(19) United States
(12) Patent Application Publication
(10) Pub. No.: US 2018/0283030 A1
(43) Pub. Date: Oct. 4, 2018

(54) POOL CLEANER WITH GEAR DRIVE AND RELATED APPARATUS AND METHODS

(71) Applicant: NC Brands L.P., Norwalk, CT (US)

(72) Inventors: Robin Owen Ellis, Pine Ridge, FL (US); Paul Lambourn, Sydenham (ZA); Michael Richard Tregoning, Edenvale (ZA)

(73) Assignee: NC Brands, L.P., Norwalk, CT (US)

(21) Appl. No.: 15/945,154

(22) Filed: Apr. 4, 2018

Related U.S. Application Data
(60) Provisional application No. 62/481,156, filed on Apr. 4, 2017.

(51) Int. Cl. E04H 4/16; G05D 1/02; B63H 19/08; B63H 23/12; B60L 15/20

(52) U.S. Cl. CPC E04H 4/1672; G05D 1/0206; B63H 19/08; B60L 2240/66; B60L 15/2036; B60L 2200/32; B60L 2240/32; B63H 23/12

(57) ABSTRACT

A pool cleaner includes a body, a water source connection, a gear drive and a suspension arrangement. The body defines a suction opening on a lower surface thereof. The gear drive is mounted to the body and includes a drive housing and a pair of gears with intermeshing teeth rotatably mounted in the drive housing. The drive housing is in fluid communication with the water source connection such that associated water flow is directed around the pair of gears, imparting rotational motion thereto. The suspension arrangement is driven by the gear drive and supports the body for motion over a pool surface. An alternator can be driven by the gear drive and power various electric components. A skirt assembly and ducts above the water source connection can improve suction. The gear drive can be used to power other pool devices.

### CROSS-REFERENCE TO RELATED APPLICATION

This application claims the benefit of U.S. Provisional Patent Application Ser. No. 62/481,156, filed on Apr. 4, 2017, the contents of which are herein incorporated by reference in their entirety.

### FIELD OF THE INVENTION

The present invention relates to pool cleaners, and more particularly, to drive mechanisms for pool cleaners and related apparatus.

### BACKGROUND OF THE INVENTION

A variety of water-driven pool cleaners have been developed over the years, falling into two basic categories: pressure-driven cleaners and suction-driven cleaners. In the former, the pool cleaner typically receives water from a pressurized water return connection, while in the latter the pool cleaner is connected to a suction connection. In pressure-driven cleaners, some type of venturi arrangement is utilized to generate suction for debris removal, which is then stored in some type of debris bag or other storage volume on the cleaner. In suction-driven cleaners, the suction force generated via the suction connection is generally used directly, and debris is typically removed via the suction connection. In both pressure- and suction-driven cleaners, there is often a turbine provided which is driven by the water flow and in turn used to drive wheels, treads or the like which impel the cleaner over the pool surface.

There is often gearing associated with these turbines for transferring the rotational motion generated by the turbine to the wheels or treads, as well as gearing for executing a mechanical “program” of periodic reversals and/or direction changes. This program feature can be necessary to ensure that the pool cleaner traverses all of the pool surface to be cleaned within a reasonable period of time.

Additionally, on wheeled or treaded cleaners, some clearance must be maintained between the pool surface and the bottom of the cleaner. To prevent excessive dispersal of suction forces and decreased cleaning effect, it is often necessary to arrange some type of skirt around the suction opening of the cleaner. These skirts are sometimes made flexible and/or segmented to avoid becoming caught on obstacles. While components of existing pool cleaners exist to meet these and other functional requirements, further improvements are possible.

### SUMMARY OF THE INVENTION

In view of the foregoing, it is an object of the present invention to provide an improved pool cleaner, including a gear drive for providing power thereto, as well as related apparatus and methods. According to an embodiment of the present invention, a pool cleaner includes a body, a water source connection, a gear drive and a suspension arrangement. The body defines a suction opening on a lower surface thereof. The gear drive is mounted to the body and includes a drive housing and a pair of gears with intermeshing teeth rotatably mounted in the drive housing. The drive housing is in fluid communication with the water source connection such that associated water flow is directed around the pair of gears, imparting rotational motion thereto. The suspension arrangement is driven by the gear drive and supports the body for motion over a pool surface.

According to an aspect of the present invention, the gear drive drives an alternator used to drive electrical components of the pool cleaner. A microcontroller powered by the alternator is configured with program instructions to control the electrical components.

According to another aspect of the present invention, a pool cleaner includes a skirt assembly extending from the lower surface of the body surrounding the suction opening, the skirt assembly includes a plurality of slide members mounted in respective slots extending inwardly from opposite sides of the lower surface of the body, each of the slide members extending downwardly from the lower surface of the body and being displaceable upwardly within its respective slot upon encountering an obstruction.

According to an additional aspect of the present invention, a first duct extends into the body above the first suction opening, the first duct tapering inwardly from the first suction opening and incorporating a spiral pattern. The body can further define a second suction opening on the lower surface thereof, with a second duct extending into the body above the second suction opening, tapering inwardly from the second suction opening and incorporating a spiral pattern. The respective spin directions of the spiral patterns of the first and second ducts can be opposite.

These and other objects, aspects and advantages of the present invention will be better appreciated in view of the drawings and following detailed description of preferred embodiments.

### BRIEF DESCRIPTION OF THE DRAWINGS

FIG. 1 is an upper perspective view of a pool cleaner, according to an embodiment of the present invention;

FIG. 2 is a lower perspective view of the pool cleaner of FIG. 1, showing a skirt assembly thereof;

FIG. 3 is an upper perspective view of the pool cleaner of FIG. 1, with a cover removed to show a gear drive and transmission assembly thereof;

FIG. 4 is an upper perspective view of the pool cleaner of FIG. 1, with the cover and a debris container removed;

FIG. 5 is a side view of the chassis of the pool cleaner of FIG. 1, with wheels removed to show skirt assembly component details;

FIG. 6 is a rear view of the pool cleaner of FIG. 1, with the cover, the debris container, and a chassis removed;

FIG. 7 is a rear upper perspective view of the gear drive and transmission assembly of FIG. 3;

FIG. 8 is a forward upper perspective view of the gear drive and transmission assembly of FIG. 3, with some transmission assembly components removed to show details;

FIG. 9 is a front sectional view of the gear drive of FIG. 3;

FIG. 10 is a side view of a pool cleaner, according to another embodiment of the present invention;

FIG. 11 is a rear view of a gear drive, according to another embodiment of the present invention;

FIG. 12 is a sectional view taken along line 11-11 of FIG. 11; and

FIGS. 13 and 14 are schematic views of a pool cleaner, according to further embodiments of the present invention.

### DETAILED DESCRIPTION OF PREFERRED EMBODIMENTS

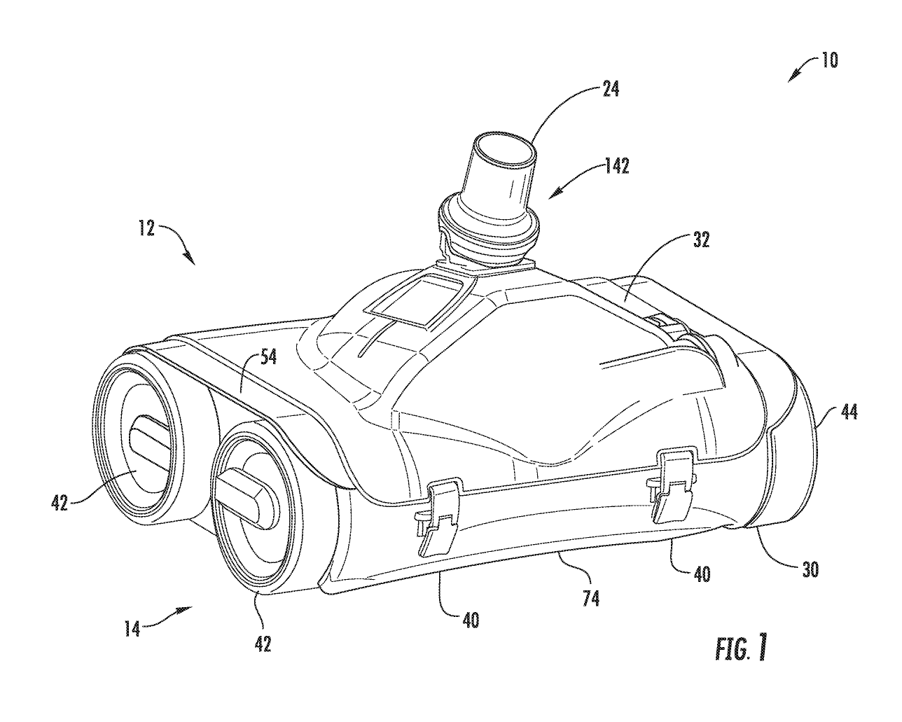

Referring to FIGS. 1-4, according to an embodiment of the present invention, a pool cleaner 10 includes a body 12 supported for motion over a pool surface by a suspension arrangement 14. A skirt assembly 16 extending from a lower surface of the body 12 surrounds one or more suction openings 18 through which debris is removed from the pool surface. A gear drive 20 drives one or more elements of the suspension arrangement 14 via a transmission assembly 22, powered by water via a water source connection 24.

The body 12 includes a chassis 30 and a cover 32. The suspension arrangement 14 is connected to the chassis 30, which supports the gear drive 20 and transmission assembly 22. The suction openings 18 are formed through a lower surface 34 of the chassis 30 with the skirt assembly 16 extending downwardly from edges thereof. The chassis 30 defines an upper opening 36 which is closed by the cover 32. Preferably, one or more releasable fasteners 40, such as latches, hold the cover 32 in place over the upper opening 36. The fit between the cover 32 and the chassis 30 should be sufficiently tight to avoid unwanted water flow therebetween and ensure sufficient suction is generated at the suction openings 18.

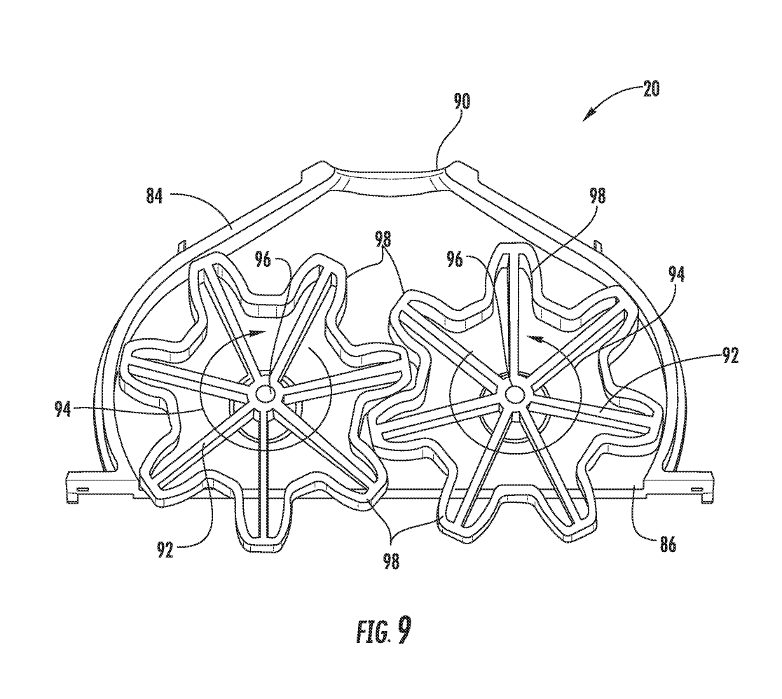

In the depicted arrangement, the suspension arrangement 14 includes a plurality of wheels 42, one or more of which is driven by the gear drive 20 via the transmission assembly 22. An appropriate tread 44 can be applied to all or a portion of the wheels 42 to ensure sufficient engagement with the underlying pool surface. The suspension arrangement 14 is not necessarily limited to a particular number or configuration of wheels 42. For example, two- and three-wheel configurations could also be used. Additionally, other types of suspension arrangements could be employed. For instance, referring to FIG. 10, a pool cleaner 10A could be equipped with a suspension unit 14A employing tracks 44A driven by drive wheels 42A (only one side shown).

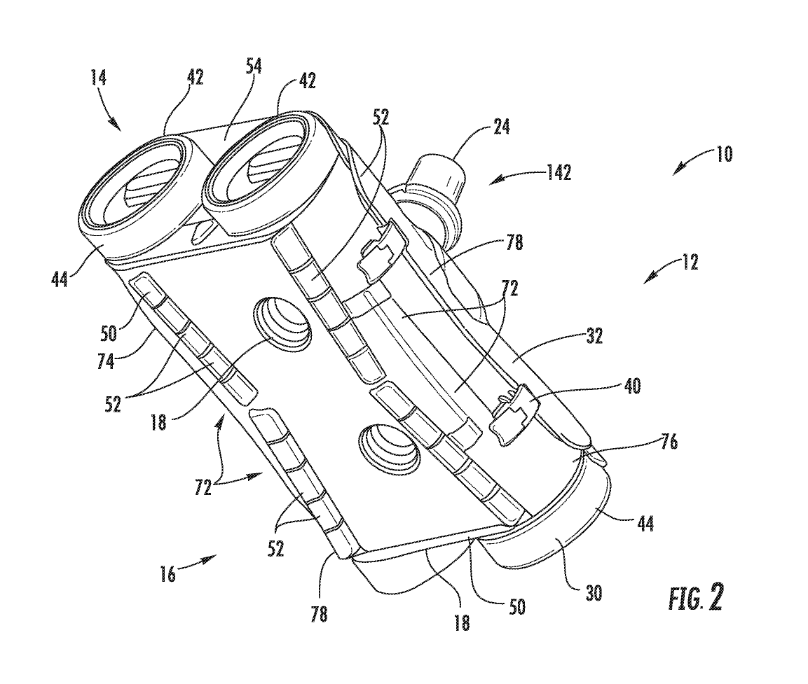

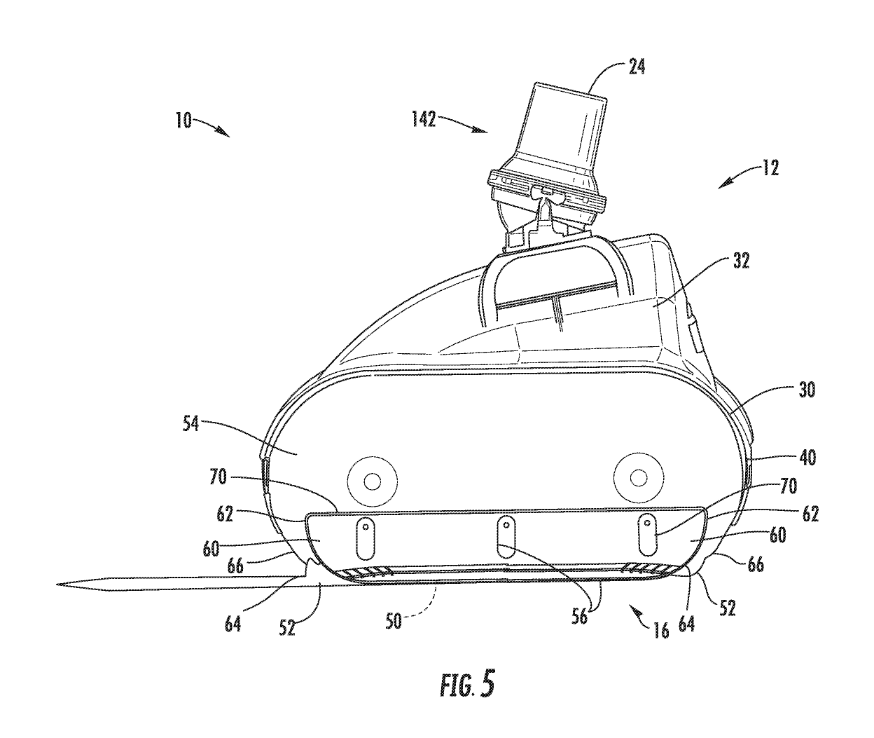

Referring more particularly to FIGS. 2 and 5, the skirt assembly 16 includes side plates 50 and a plurality of slide members 52. The side plates 50 are mounted to opposite sides 54 of the chassis 30 via elongated slots 56, allowing the plates 50 to move upwardly as needed to avoid interference with the underlying pool surface. While unitary side plates 50 are shown in the depicted embodiment, it will be appreciated that segmented side plates 50 could also be used.

The slide members 52 are arranged in slots 60 extending inwardly from the sides 54 of the chassis 30. Each of the slide members 52 includes a retention portion 62 retained within the slot 60 and a rounded lower portion 64 for engagement with the pool surface. A reduced thickness neck 66 extends through the slot 60 and connects the retention portion 62 and the lower portion 64. A free space 70 above each slot 60 allows the slide member 52 to be urged upwardly, as needed, to permit larger debris and/or pool surface obstructions to pass thereunder. With the wheels 42 and side plates 50 removed, the slide members 52 can be removed and replaced via the sides of the chassis 30.

In the depicted embodiment, the slide members 52 are arranged in four separate banks 72. Two banks 72 extend inwardly from opposite sides 54 proximate a front side 74 of the chassis, while two banks 72 extend inwardly from opposite sides 54 proximate a rear side 76 of the chassis 30. Advantageously, the forward banks 72 each angle slightly to the rear and the rear banks 72 each angle slightly to the front, such that each set of two adjacent banks 72 forms a shallow “V” shape with an apex directed toward the center of the lower surface 34 of the chassis 30. This configuration can assist in the funneling of debris through the skirt assembly 16 during movement of the pool cleaner 10 in forward and reverse directions. A straight configuration or other configurations could also be employed.

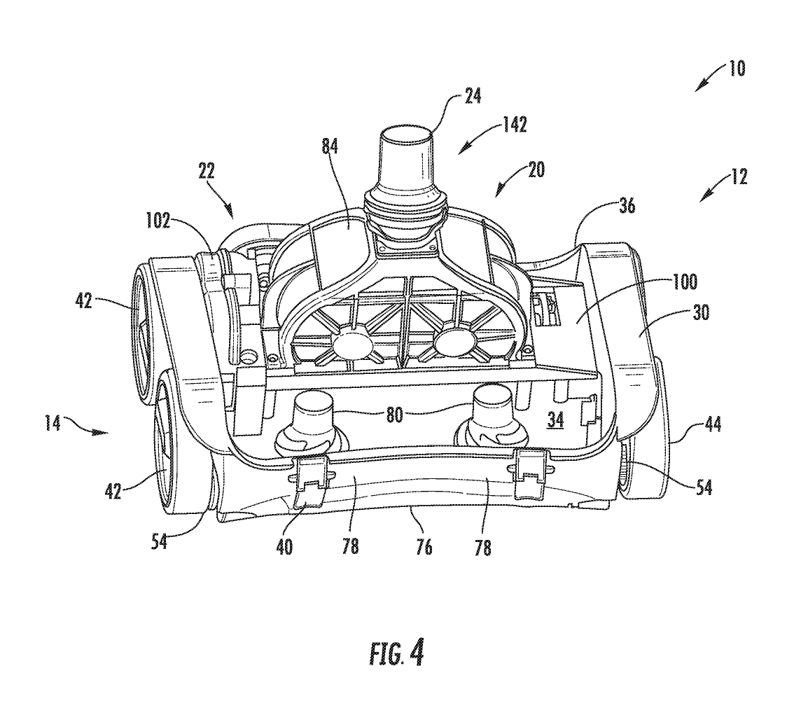

Generally, the skirt assembly 16 increases the efficacy of the suction forces imparted via the suction openings 18 at removing dirt and debris from the area of the pool surface immediately underlying the pool cleaner 10. Additionally, enhancing the suction effect, ducts 78 are located above the openings 18, which taper inwardly therefrom and incorporate a spiral pattern (see FIGS. 2 and 4). This channels and increases the velocity of water flow, helping to better ensure water-entrained debris is drawn into the body 12 of the pool cleaner. In the depicted embodiment, the spin direction of the spiral patterns are opposite for the two ducts 78.

While the skirt assembly 16 is particularly advantageous for use in connection with the depicted pool cleaner 10, it will be appreciated that the skirt assembly could be advantageously employed in connection with other pool cleaners, including—for example—pool cleaners not equipped with a gear drive 20 and/or pressure-driven pool cleaners.

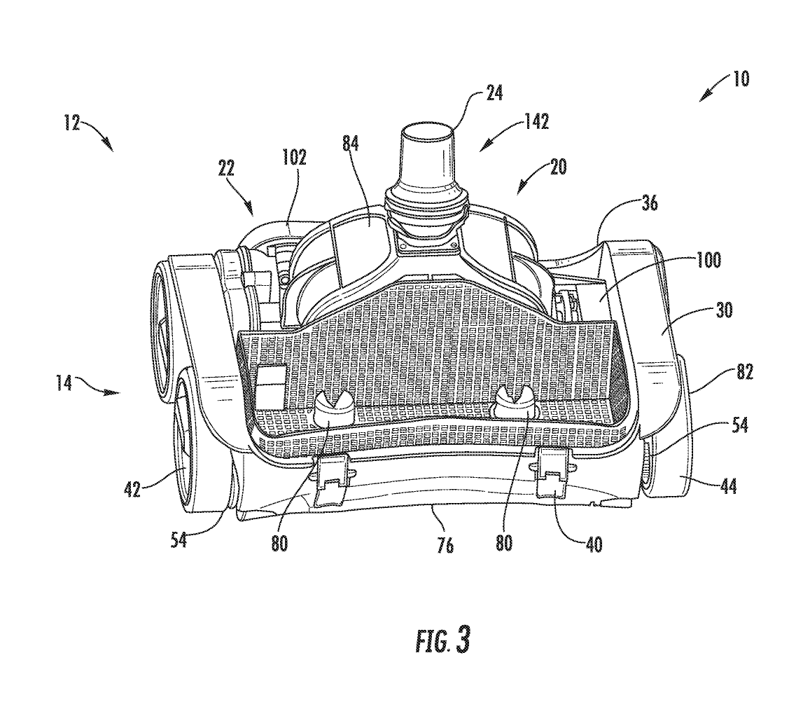

Referring also to FIG. 3, within the body 12, the ducts 78 terminate at outlets 80 located within a filter basket 82. Consequently, with the cover 32 in place, all water entering the body 12 via the suction openings 18 must pass through the filter basket 82. Debris larger than an opening size of the filter basket 82 is therefore retained within the filter basket 82, from whence it can be periodically emptied by removing the cover 32 and the basket 82. In the depicted embodiment, after passing through the filter basket 82, water flow (and any remaining entrained debris) passes through the gear drive 20 and out through the water source connection 24.

The present invention is not necessarily limited to use in connection with an internal collection volume like the filter basket 82. For instance, a pool cleaner without any sort of collection volume could be used (i.e., such that all debris was simply passed to the pool water recirculation system for removal). Additionally, external collection volumes could be used; for example, external collection bags used in connection with certain pressure-driven cleaners).

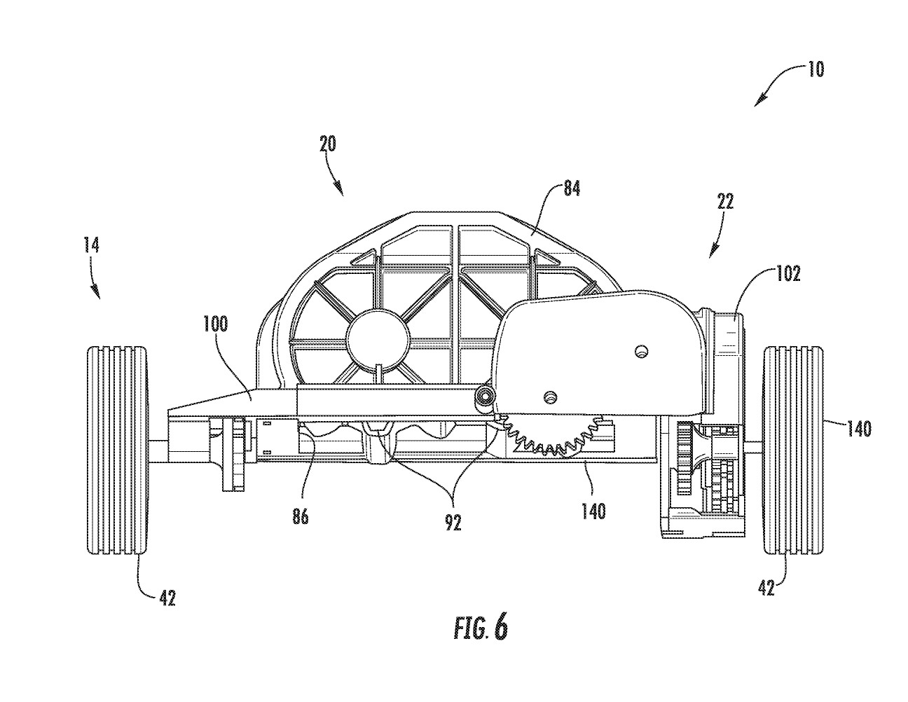

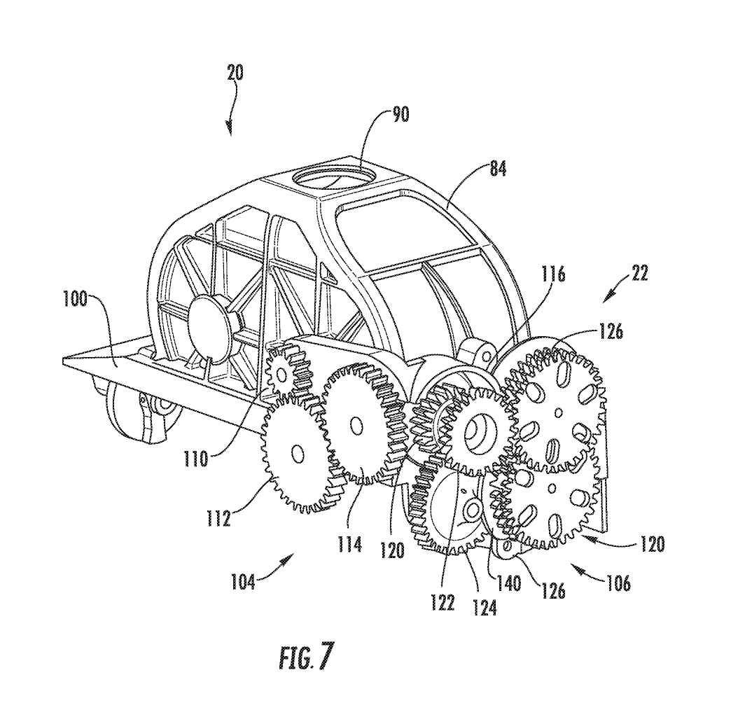

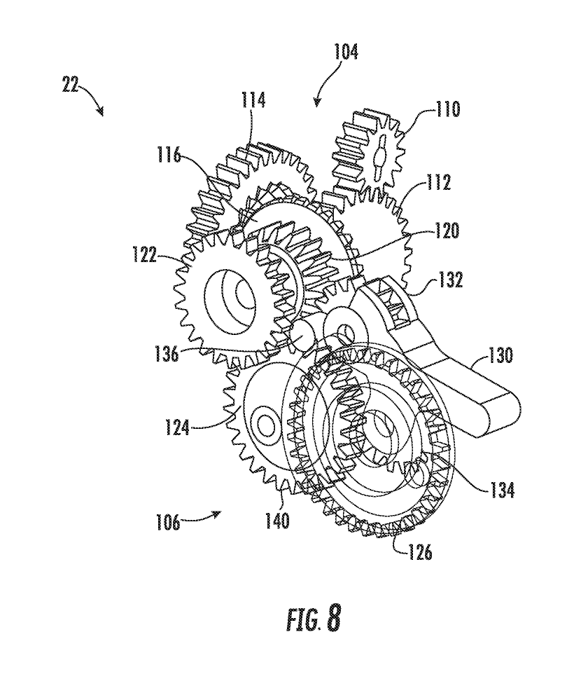

Referring to FIGS. 6-9, the gear drive 20 includes a drive housing 84 having lower and upper openings 86, 90. A pair of gears 92 with intermeshing teeth are rotatably mounted to the housing 84. In the depicted pool cleaner 10, water is drawn in through the lower opening 86, from whence it travels along the sides of the housing 84 to the upper opening 90 causing the gears 92 to counter-rotate as indicated by arrows 94. The gears 92 are mounted on axles 96 supported by the housing 84.

The depicted shape of gear teeth 98 is believed to be preferred, but other shapes and configurations can be used in connection with the present invention. The tolerance between gears 92/teeth 98 should be close enough to result in sufficient force generation due to water flow while loose enough to permit expected debris to pass without jamming. To further facilitate passage of debris, the gears 92 could be resiliently mounted on the axles 96 and/or the teeth 98 resiliently mounted to the gears, with the play afforded thereby allowing larger obstructions to pass. Additionally, while the depicted gears 92 are molded to be hollow, cavities could be machined in the gears or solid gears could be used.

The gear drive 20 is mounted to the chassis 30 via a frame 100, holding the gear drive 20 above the lower surface 34 of the chassis 30. In the depicted embodiment, the gear drive 20 is mounted transversely, such that the axes of the gears 92 are generally perpendicular to the axes of the wheels 42. In other embodiments, the gear drive could be mounted fore-and-aft, such that the gear 92 axes would be parallel with the wheel 42 axes.

The gears 92 are fixedly mounted on axles 96, such that the rotational output of the gear drive 20 comes from the axles 96. However, the rotational output could be taken directly from the gears, allowing a fixed axle to be used. Also, the gears need not have parallel axes—gears intermeshing at a 90 degree angle could be used, for instance. Additionally, one or more intermediate gears could be used. For example, with a single intermediate gear located between the outer gears, the outer gears would both rotate in the same direction. More than one gear drive could also be included, with the multiple gear drives being interconnected or mechanically independent.

The transmission assembly 22 is commonly mounted on the frame 84 with the gear drive 20, and includes a transmission housing 102 to prevent fouling of transmission assembly 22 components and facilitate installation and replacement as a unit. The transmission assembly 22 is driven via engagement with at least one axle 96 of the gear drive 20, and includes a drive section 104 for transferring rotational motion from the axle 96 to the suspension arrangement 14, and a program section 106 for periodically altering a drive direction of the suspension arrangement 14.

In the depicted embodiment, the drive section 104 includes an output gear 110 connected to one the gear drive 20 axles 96. The rotational speed of the gear 110 is stepped down via engagement with a first intermediate gear 112. First intermediate gear 112 turns the second intermediate gear 114, which engages a third intermediate gear 116 at an angle—effecting a 90 degree shift in the axis of rotational motion. The third intermediate gear 116 has inner and outer races 120, 122, with the outer race 122 driving the program section 106 and the inner race 120 engaging a suspension drive gear 124 via an output of the program section 106.

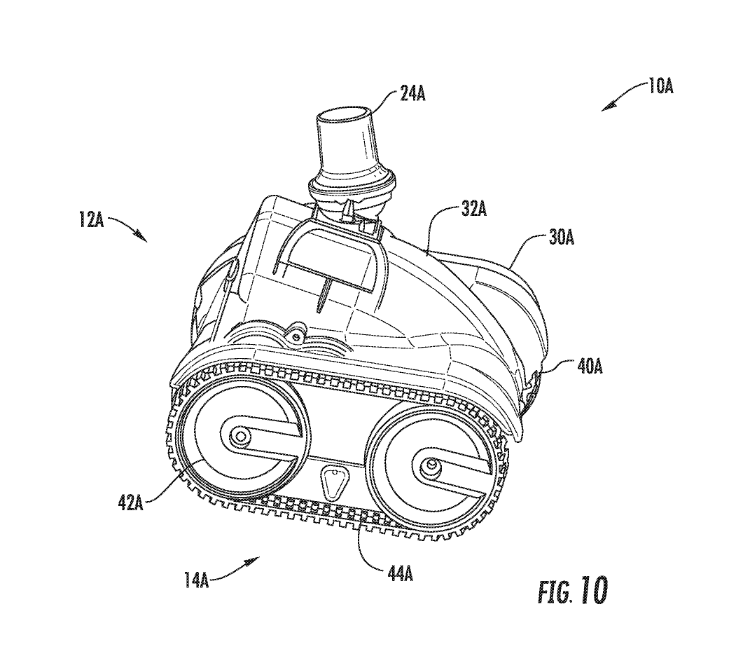

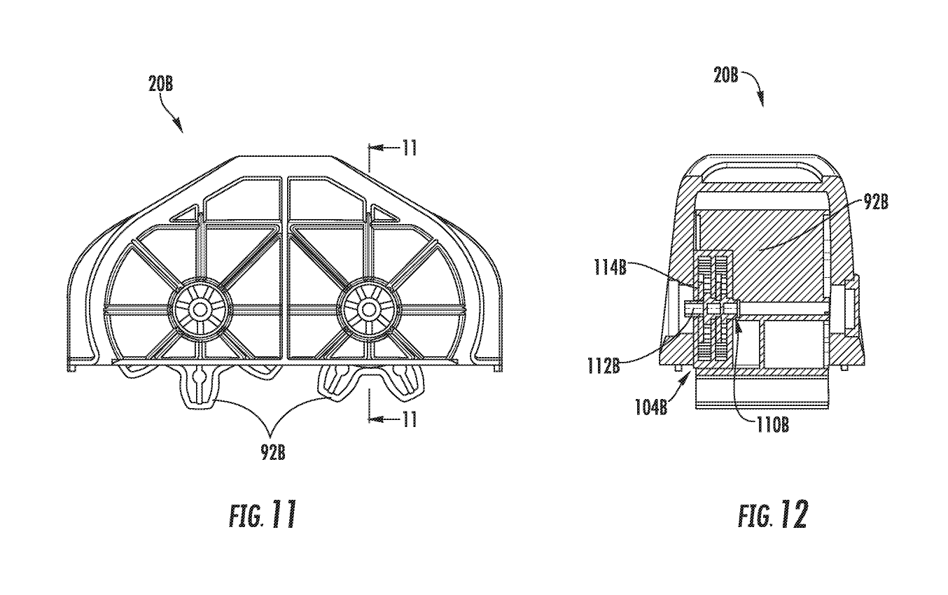

In an alternate embodiment, some or all of the transmission assembly could be located inside the gear drive. For example, referring to FIGS. 11 and 12, in a gear drive 20B, a drive section 104B of a transmission assembly is located inside one of the gears 92B. Specifically, rotation of the gear 92B drives a planetary input gear 110B rotatably mounted therein, which drives a planetary output gear 112B at a reduced rotational speed via intermediate planetary gears 114B.

The program section 106 includes a plurality of successively driven timing gears 126 and a pivotable dual gear yoke 130. The dual gear yoke 130 mounts twin intermeshing gears 132, 134 and an engagement post 136. The dual gear yoke 130 is pivoted upwardly or downwardly based on engagement of the post 136 with a cam surface 140 extending partially around the last timing gear 126. When the cam surface 140 engages the post 136, the yoke 130 is urged upwardly, and the gear 132 transfers rotational motion directly between the inner race 120 of the third intermediate gear 116 and the suspension drive gear 124—resulting in the suspension drive gear 124 rotating in the same direction as the third intermediate gear 116. When cam surface 140 is rotated out of engagement with the post 136, the yoke 130 pivots downwardly, and the gear 132 transfers rotational motion indirectly to the suspension drive gear 124 via the gear 134—resulting in the suspension drive gear 124 rotating in an opposite direction from the third intermediate gear 116.

The suspension drive gear 124 drives at least one of the wheels 42 (or other suspension component) via a drive shaft 140. Preferably the drive shaft 140 drives two opposite wheels 42 for motion in the forward direction, while a unidirectional clutch or the like disengages one of the wheels 42 during movement in the reverse direction—thus helping to vary the travel pattern of the pool cleaner 10 over the pool surface. Additionally, the transmission assembly 22 could be configured to allow user selection of cleaner 10 speed—for instance, allowing a user to choose between a more thorough cleaning at a slower speed and quicker cleaning at a faster speed.

In the depicted pool cleaner 10, only one gear drive 20 axle 96 is used to drive a single transmission assembly 22. However, the presence of two axles 96 permits the use of two transmission assemblies 22 independently driving the suspension arrangement 14 on opposite sides of the cleaner 10. Various other transmission assemblies 22 could also be employed—including assemblies not featuring program functions. The gear drive 20 could also be used to drive other pool cleaner 10 components, such as an alternator for supplying electrical components (e.g., lights, motors, microcontrollers, etc.).

Referring again to FIG. 1, at the upper opening 90 of the gear drive, the water source connection 24 advantageously includes a swivel ball mechanism 142, allowing a connected hose to both rotate and pivot fore-and-aft relative to the pool cleaner 10. Other connections could also be employed, as desired. The depicted pool cleaner 10 is a suction-driven pool cleaner; it will be appreciated that the gear drive 20 could readily be employed in a pressure-driven cleaner to drive a suspension arrangement thereof. Additionally, the gear drive could be employed to generate motive, program and/or electrical power in other types of pool tools. For example, the gear drive could be employed in a surface skimmer, a combination vacuum/skimmer, etc.

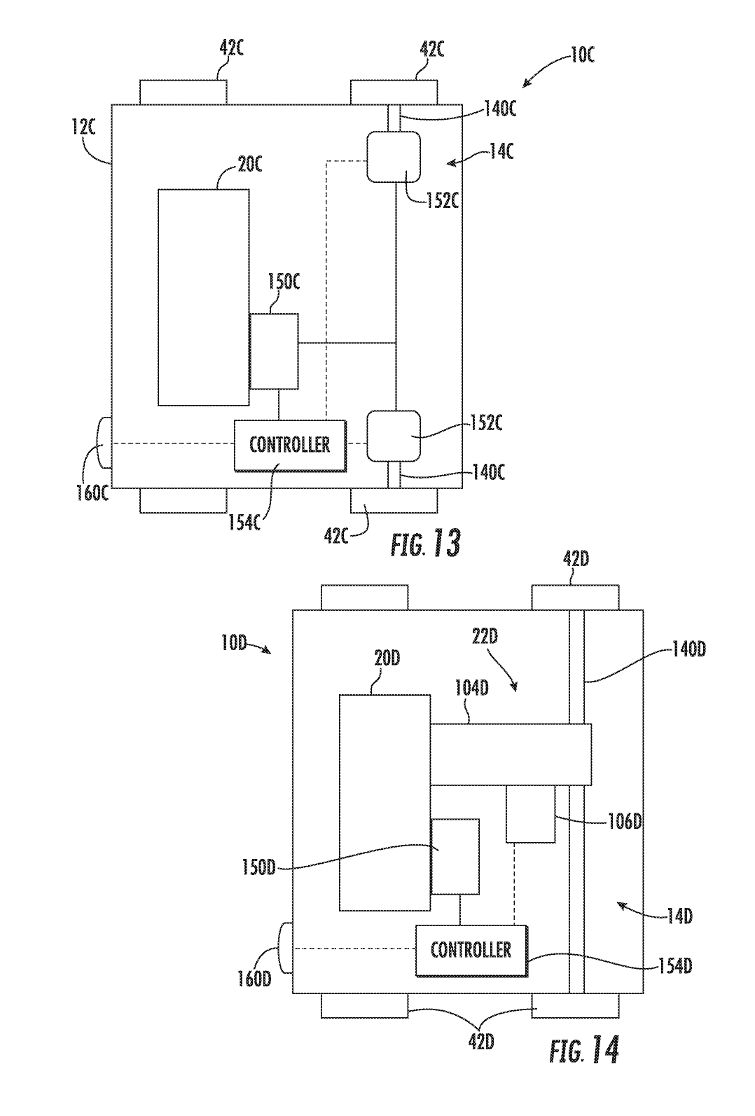

As noted above, the gear drive 20 could be used to power an alternator to supply electrical components. Such an arrangement can greatly increase the range and flexibility of functions offered in a pool cleaner. For example, referring to FIG. 13, a pool cleaner 10C includes a gear drive 20C driving an alternator 150C to generate electrical power. The alternator 150C can be of any suitable type, although an AC induction-type machine is particularly suitable. Such an alternator can include a rectifier to convert the electrical power generated by the alternator into DC power and/or additional circuitry for power conditioning, as necessary.

In the embodiment of FIG. 13, the suspension arrangement 14C includes electric motors 152C powered by the alternator 150C to drive the wheels 42C via drive shafts 140C. Advantageously, a microcontroller 154C is included. Powered by the alternator 150C, the microcontroller 154C is configured with program instructions to control the motors 152C, allowing it to control speed and direction of the motors 152C, as well as to differentially operate the motors to steer the pool cleaner 10C.

An ambient sensor 160C powered by the alternator 150C and also communicating the microcontroller 154C is beneficially further included. Various types and numbers of ambient sensors can be included to detect different pool conditions (e.g., dirt levels, presence of obstacles, light levels, chemistry conditions, etc.) The microcontroller 154C can be further configured with program instructions to alter pool cleaner operation based on the detected pool condition(s) (e.g., to move slower where dirt levels are greater, to steer around obstacles, to turn on external lights at night, to dispense chemicals, etc.).

In a different embodiment, referring to FIG. 14, the pool cleaner 10D is equipped with an alternator 150D driven by the gear drive 20D. The gear drive 20D also mechanically drives the wheels 42D via the drive section 104D of a transmission assembly 22D and a split axle 140D. However, the program section 106D of the transmission assembly 22D is controlled by the microcontroller 154D, which is configured with program instructions to operate the program section 106D and thereby vary how mechanical power is applied to the wheels 42D via the drive section. An ambient sensor 160D can also be included in communication with the microcontroller 154D, allowing functions like those discussed in connection with the microcontroller 154C.

The foregoing is provided for illustrative and exemplary purposes; the present invention is not necessarily limited thereto. Rather, those skilled in the art will appreciate that various modifications, as well as adaptations to particular circumstances, are possible within the scope of the invention as herein shown and described and of the claims appended hereto.

What is claimed is:

1. A pool cleaner comprising:
a body defining a suction opening on a lower surface thereof;
a water source connection extending from the body;
a gear drive mounted to the body, the gear drive including:
a drive housing;
a pair of gears with intermeshing teeth rotatably mounted in the drive housing, the drive housing being in fluid communication with the water source connection such that associated water flow is directed around the pair of gears, imparting rotational motion thereto; and
a suspension arrangement driven by the gear drive and supporting the body for motion over a pool surface.

2. The pool cleaner of claim 1, wherein gear axes of the pair of gears are parallel.

3. The pool cleaner of claim 2, wherein the suspension arrangement includes at least two wheels having parallel wheel axes, the gear axes being perpendicular to the wheel axes.

4. The pool cleaner of claim 1, wherein the teeth of each of the pair of gears are fixedly mounted thereto.

5. The pool cleaner of claim 1, wherein the teeth of each of the pair of gears are narrower moving radially outward from respective gear centers.

6. The pool cleaner of claim 1, wherein each of the pair of gears is mounted on a respective axle supported by the drive housing.

7. The pool cleaner of claim 6, wherein each of the pair of gears is fixed to the respective axles and the respective axles are rotatably supported by the drive housing.

8. The pool cleaner of claim 1, wherein the drive housing is also in fluid communication with the suction opening, such that the associated water flow passing to the water source connection from the suction opening is directed around the pair of gears.

9. The pool cleaner of claim 8, wherein the body includes a filter basket arranged therein, such that the associated water flow from the suction opening passes through the filter basket before being directed around the pair of gears.

10. The pool cleaner of claim 8, wherein the body includes a chassis defining an upper opening and a cover releasably closing the upper opening.

11. The pool cleaner of claim 10, wherein the gear drive is mounted to the chassis.

12. The pool cleaner of claim 11, wherein the lower surface of the body defining the suction opening is part of the chassis.

13. The pool cleaner of claim 11, wherein the suspension arrangement is supported by the chassis.

14. The pool cleaner of claim 11, wherein the water source connection extends through the cover.

15. The pool cleaner of claim 14, wherein the water source connection is mounted to a top of the drive housing and a lower opening of the drive housing communicates with an interior of the body enclosed by the chassis and cover.

16. The pool cleaner of claim 15, wherein the drive housing is also in fluid communication with the suction opening, such that the associated water flow passing to the water source connection from the suction opening is directed into the interior of the body, through the lower opening of the drive housing, around the pair of gears and out through the top of the drive housing to the water source connection.

17. The pool cleaner of claim 16, wherein a filter basket is arranged in the interior of the body between the suction opening and the lower opening of the drive housing, such that the associated water flow from the suction opening passes through the filter basket before being directed into the drive housing and around the pair of gears.

18. The pool cleaner of claim 1, wherein another suction opening is defined in the lower surface of the body.

19. The pool cleaner of claim 1, further comprising a skirt assembly extending from the lower surface of the body surrounding the suction opening.

20. The pool cleaner of claim 19, wherein the skirt assembly includes a plurality of slide members mounted in respective slots extending inwardly from opposite sides of the lower surface of the body, each of the slide members extending downwardly from the lower surface of the body and being displaceable upwardly within its respective slot upon encountering an obstruction.

21. The pool cleaner of claim 20, wherein the skirt assembly further includes a pair of side plates arranged on the opposite sides of the body and extending downwardly therefrom.

22. The pool cleaner of claim 1, further comprising a transmission assembly receiving the rotational motion from the gear drive and driving the suspension arrangement in turn.

23. The pool cleaner of claim 22, wherein the transmission assembly includes a drive section transferring the rotational motion from the gear drive to the suspension arrangement.

24. The pool cleaner of claim 23, wherein the transmission assembly further includes a program section operable to periodically alter a drive direction of the suspension arrangement.

25. The pool cleaner of claim 22, wherein the transmission assembly is mounted externally to the drive housing.

26. The pool cleaner of claim 25, wherein the transmission assembly is located inside the body within a transmission housing.

27. The pool cleaner of claim 22, wherein the transmission assembly is located inside one of the pair of gears of the gear drive.

28. The pool cleaner of claim 1, wherein the water source connection includes a swivel ball mechanism allowing a connected hose to both rotate and pivot relative to the pool cleaner.

29. The pool cleaner of claim 1, wherein the suspension arrangement includes a pair of wheels rotatably mounted at opposite sides of the body.

30. The pool cleaner of claim 29, wherein the suspension arrangement includes another pair of wheels rotatably mounted at opposite sides of the body.

31. The pool cleaner of claim 29, wherein the suspension arrangement further includes a pair of tracks respectively driven by the pair of wheels.

32. The pool cleaner of claim 1, further comprising an alternator mounted to the body and driven by the gear drive to generate electrical power.

33. The pool cleaner of claim 32, wherein the suspension arrangement includes a first electric motor powered by the alternator.

34. The pool cleaner of claim 33, further comprising a microcontroller powered by the alternator and configured with program instructions to control the first electric motor.

35. The pool cleaner of claim 34, wherein the suspension arrangement includes a second electric motor powered by the alternator and the microcontroller is further configured with program instructions to differentially control the second electric motor relative to the first electric motor to steer the pool cleaner.

36. The pool cleaner of claim 32, further comprising a transmission assembly receiving the rotational motion from the gear drive and driving the suspension arrangement in turn;
wherein the transmission assembly includes a drive section transferring the rotational motion from the gear drive to the suspension arrangement.

37. The pool cleaner of claim 36, wherein the transmission assembly further includes a program section electrically driven by the alternator and operable to alter a drive direction of the suspension arrangement.

38. The pool cleaner of claim 37, further comprising a microcontroller powered by the alternator and configured with program instructions to control the program section.

39. The pool cleaner of claim 32, further comprising:
an ambient sensor powered by the alternator and operable to detect a swimming pool condition; and
a microcontroller powered by the alternator and in communication with the ambient sensor, the microcontroller being configured with program instructions to alter operation of the pool cleaner based on the pool condition detected by the ambient sensor.

40. A pool cleaner comprising:
a body defining a suction opening on a lower surface thereof;
a water source connection extending from the body;
a suspension arrangement supporting the body for motion over a pool surface;
a drive mounted to the body and operable to drive the suspension arrangement; and
a skirt assembly extending from the lower surface of the body surrounding the suction opening, the skirt assembly includes a plurality of slide members mounted in respective slots extending inwardly from opposite sides of the lower surface of the body, each of the slide members extending downwardly from the lower surface of the body and being displaceable upwardly within its respective slot upon encountering an obstruction.

41. The pool cleaner of claim 40, wherein each slide member includes a retention portion arrangement in its respective slot, a lower portion for engagement with the pool surface and a reduced thickness portion extending through the slot connecting the retention portion and the lower portion, the retention portion not being withdrawable downwardly through the slot.

42. The pool cleaner of claim 41, wherein a free space is defined above each respective slot, the free space allowing the upward displacement of each slide member.

43. The pool cleaner of claim 42, wherein each respective slot extends to at least one of two opposite edges of the lower surface of the body, each slide member being removable from its respective slot thereat.

44. The pool cleaner of claim 43, wherein the skirt assembly further includes at least one side plate removable arranged at the at least one of two opposite edges of the lower surface of the body, the slide plate preventing removal of the of the slide members.

45. The pool cleaner of claim 44, wherein the suspension assembly includes at least one wheel mounted at the at least one of two opposite edges of the lower surface of the body, the at least one wheel being mounted outwardly of the at least one slide plate.

46. The pool cleaner of claim 40, wherein the respective slots include four slots, the plurality of slide members being arranged in the four slots in four banks, the four banks including two front banks and two rear banks, the two front banks extending inwardly from opposite sides of the lower surface of the body proximate a front side thereof and the two rear banks extending inwardly from opposite sides of the lower surface of the body proximate a rear side thereof.

47. The pool cleaner of claim 46, wherein each of the two forward banks angles to the rear and each of the two rear banks angles slightly to the front such that the two forward banks and two rear banks each form a “V” shape with an apex directed toward the center of the lower surface of the body.

48. The pool cleaner of claim 40, wherein the skirt assembly further includes a pair of side plates arranged on the opposite sides of the body and extending downwardly therefrom.

49. A pool cleaner comprising:
a body defining a first suction opening on a lower surface thereof, a first duct extending into the body above the first suction opening, the first duct tapering inwardly from the first suction opening and incorporating a spiral pattern;
a water source connection extending from the body;
a suspension arrangement supporting the body for motion over a pool surface; and
a drive mounted to the body and operable to drive the suspension arrangement.

50. The pool cleaner of claim 49, wherein the body further defines a second suction opening on the lower surface thereof, a second duct extending into the body above the second suction opening, the second duct tapering inwardly from the second suction opening and incorporating a spiral pattern.

51. The pool cleaner of claim 50, wherein respective spin directions of the spiral patterns of the first and second ducts are opposite.

52. The pool cleaner of claim 50, further comprising a skirt assembly extending from the lower surface of the body surrounding the suction opening, the skirt assembly includes a plurality of slide members mounted in respective slots extending inwardly from opposite sides of the lower surface of the body, each of the slide members extending downwardly from the lower surface of the body and being displaceable upwardly within its respective slot upon encountering an obstruction.

53. The pool cleaner of claim 52, wherein the skirt assembly further includes a pair of side plates arranged on the opposite sides of the body and extending downwardly therefrom.

54. The pool cleaner of claim 49, further comprising a filter basket arranged within the body, the ducts terminating at outlets located within the filter basket.

55. A water-powered pool device comprising:
a body;
a water source connection extending from the body; and
a gear drive mounted to the body, the gear drive including:
a drive housing;
a pair of gears with intermeshing teeth rotatably mounted in the drive housing, the drive housing being in fluid communication with the water source connection such that associated water flow is directed around the pair of gears, imparting rotational motion thereto.

56. The pool device of claim 55, further comprising a suspension arrangement driven by the gear drive and supporting the body for motion over a pool surface.

57. The pool device of claim 56, wherein the body defines a suction opening on a lower surface thereof.

58. The pool device of claim 55, further comprising an alternator mounted to the body and driven by the gear drive to generate electrical power.

59. The pool device of claim 58, further comprising a microcontroller powered by the alternator and being configured with program instructions to alter operation of the pool device.

60. The pool device of claim 59, further comprising an ambient sensor powered by the alternator and operable to detect a swimming pool condition;
wherein the microcontroller is configured with program instructions to alter operation of the pool cleaner based on the pool condition detected by the ambient sensor.
